(19) United States
(12) Patent Application Publication
(10) Pub. No.: US 2022/0077729 A1
(43) Pub. Date: Mar. 10, 2022

(54) STATOR TOOTH FOR A STATOR OF AN ELECTRIC MACHINE

(71) Applicant: Rolls-Royce Deutschland Ltd & Co KG, Blankenfelde-Mahlow (DE)

(72) Inventor: Johannes Gabriel Bauer, Neuried (DE)

(21) Appl. No.: 17/415,892

(22) PCT Filed: Dec. 6, 2019
(86) PCT No.: PCT/EP2019/084048

§ 371 Date: Jun. 18, 2021

(30) Foreign Application Priority Data
Dec. 19, 2018 (DE) 10 2018 222 228.2

(51) Int. Cl. H02K 1/16; H02K 3/16; B64D 27/24

(52) U.S. Cl. CPC H02K 1/165; H02K 3/16; H02K 2201/03; H02K 2213/03; B64D 27/24

(57) ABSTRACT

The disclosure relates to the design of a stator tooth for a stator of an electric machine, in particular, for an electric drive system of an aircraft. The stator tooth is formed from a multiplicity of sheet metal layers which are stacked on one another in an axial direction. At least those sheet metal layers which delimit the stator tooth in the axial direction have slits which extend in the radial direction and which have the effect of suppressing eddy currents generated in the sheet metal layers, for example, by stray fields, during the operation of the electric machine.

The present patent document is a § 371 nationalization of PCT Application Serial No. PCT/EP2019/084048, filed Dec. 6, 2019, designating the United States, which is hereby incorporated by reference, and this patent document also claims the benefit of German Patent Application No. 10 2018 222 228.2, filed Dec. 19, 2018, which is also hereby incorporated by reference.

### TECHNICAL FIELD

The disclosure relates to a stator of an electric machine. In particular, the disclosure relates to the design of the stator teeth of the stator.

### BACKGROUND

As an alternative to certain internal combustion machines, concepts based on electric drive systems are being tested and used for propelling aircraft, (e.g., airplanes or helicopters), or also for electrically-powered watercraft, etc. Such an electric drive system, which may be configured as a purely electric or also as a hybrid-electric drive system, may have one or more electric machines which, depending on the application in the drive system, may be configured as generators and/or as electric motors. The electric drives and the corresponding machines to be used for such mobile applications are distinguished by an extremely high power density in order to be able to generate the required power levels. While power densities of the order of up to 2 kW/kg are sufficient for many technical applications, electric machines having power densities which may be in the order of magnitude of, e.g., 20 kW/kg and more are pursued for the electrification of aviation, (e.g., for electrically or hybrid-electrically driven aircraft), and also for other, in particular mobile, applications.

For the mobile applications, accordingly electric machines with high power density are required. In electric machines however, because of various effects, losses occur which limit the achievable power density. The losses occurring in the active material of a stator of the machine are known as copper and core losses, wherein the core losses may in turn be divided into hysteresis and eddy current losses. Eddy current losses result from the electrical eddy currents in the core of the stator, which in turn are provoked by the main magnetic flux. To limit the eddy currents, the stator may be configured in plated form. Here, the stator is formed from a series of plate layers, wherein an isolating layer is arranged between every two plate layers. The presence of the isolating layers means that the current paths of the eddy currents are interrupted, so that the eddy current components in particular come to lie in a direction perpendicular to the respective isolating layer. Eddy current components within a respective plate layer may however continue to flow largely unhindered and thus lead to losses. These eddy current components in the plane of the plate are particularly pronounced in the two plate layers lying at the end regions of the stator, as will be explained in more detail below, and result in locally very high loss densities.

The eddy current losses occurring in the end regions in particular, as a result of leakage fields, may be reduced by enlarging the air gap formed between the stator teeth and the rotor. Such a measure however disadvantageously also leads to a reduction in torque. A further approach for restricting the eddy current losses may be to use a winding head which is extended in the axial direction. This is however associated with an additional necessary conductor length and hence with increased ohmic losses. Furthermore, the fact that leakage fields increase with saturation of the core in the main flux path may be utilized. A larger core cross-section would accordingly lead to a lower saturation and weaker leakage fields but is associated with an increase in the core mass. Also, to reduce eddy currents, a material with lower electrical conductivity may be used, but this also has a negative influence on the magnetic properties of the plate. All four measures outlined above thus consequently lead to a reduction in power density.

### SUMMARY AND DESCRIPTION

It is therefore an object of the present disclosure to indicate a further possibility for reducing eddy current losses in an electric machine, which does not have a significantly negative effect on the power density, e.g., in contrast to the methods. A further object is to improve the drive of an aircraft equipped with such an electric machine.

This is achieved by the stator tooth, by the electric machine formed with such stator teeth, and by an aircraft equipped with such a machine, as disclosed herein. The scope of the present disclosure is defined solely by the appended claims and is not affected to any degree by the statements within this summary. The present embodiments may obviate one or more of the drawbacks or limitations in the related art.

A stator tooth for a stator of an electric machine has a tooth head, a tooth foot, and a tooth neck lying between the tooth head and the tooth foot in a first direction R. Slots are provided in the tooth head which extend from the tooth head in the direction towards the tooth foot, wherein this does not necessarily mean that the slots extend as far as the tooth foot, which slots are arranged and oriented such that eddy current components in the R-U plane, which may be provoked by a magnetic leakage field acting in the region of the stator tooth during operation of the electric machine, are at least reduced. The directions R, U, and also A below correspond to a radial direction R, an axial direction A, and a tangential direction U, which may be defined with respect to a rotational axis ROT of a rotor of the electric machine. The slots cause a suppression of eddy current components in particular in the regions of the stator tooth in which the slots are formed.

The slots extend from a surface of the tooth head which faces away from the tooth foot and, in the state installed in the stator, towards a rotor of the electric machine, in the first direction R towards the tooth foot. Because the slots start directly from the surface and, accordingly and consequentially, no electrically conductive material is present between the surface and the respective slot when viewed in particular in the R direction, no eddy current path may form there. If the slots were to lie at a certain distance below the surface, an eddy current path may run between the surface and the respective slot.

Viewed in the first direction R, the slots may extend beyond the region of the tooth head up to the tooth neck, because the leakage field is expected to still have an effect there.

Viewed in the first direction R, the stator tooth has a groove depth n and the slots have an extent or slot depth r from the surface. For the ratio of the slot depth r to the groove depth n, the following applies: ⅓<r/n<½, because the strongest leakage fields are expected in these regions of the stator tooth.

The ratio r/n which is finally optimal for the individual machine may be determined, e.g., via a digital optimization which takes account of the individual machine parameters.

The slots are oriented such that, in the state installed in the electric machine, they extend parallel to the field lines running in the region of the slots, of a main magnetic flux H occurring during operation of the electric machine, so that the main magnetic flux H is not obstructed, because such an obstruction would lead to a reduction in power density.

Because the operating conditions and the occurrence of the magnetic fields ultimately depend on the machine design, it may be assumed that the field geometry is known sufficiently precisely to position and orient the slots accordingly.

The stator tooth is constructed from a plurality N of separate plate layers stacked one upon the other in a second direction A, which in particular stands substantially perpendicular to the first direction R. An electrically isolating layer may be arranged between every two adjacent plate layers, so as to suppress the formation of eddy currents resulting from the main magnetic flux. The plurality N of plate layers is divided into a first group with N1 stacked plate layers, a second group with N2 stacked plate layers, and an optional third group with N3 stacked plate layers, wherein N1+N2+N3=N and N1≥1, N2≥1 and N3≥0. The three groups are stacked one upon the other such that, viewed in the second direction A, the optional third group is arranged between the first group and the second group. The first and second groups may have the same number of plate layers, i.e., N1=N2=K/2. Furthermore, each plate layer of the first group and each plate layer of the second group has at least one slot, e.g., a plurality of slots.

In principle, it is open whether the third, centrally arranged group also includes plate layers with slots. At least, however, the plate layers of the first and second group have slots. In principle, each of the three groups may include only a single plate layer.

The isolating layers and the slots in principle have the same effect, namely an interruption of current paths of corresponding eddy currents. Because of the particular arrangement and orientation of the slots, in particular they suppress a tangential component of the eddy current, which would otherwise be provoked in particular by the leakage field S in the respective plate layer. In contrast, the isolating layers substantially suppress axial eddy current components.

The first group and the second group each include at least one slotted plate layer, (e.g., N1=N2=1). In the case that N1=N2=1, the two single slotted plate layers are consequently the two plate layers of the plurality of plate layers which delimit the stator tooth when viewed in the second direction A, e.g., the slots are then only provided in the plate layers delimiting the stator tooth. The two groups may each have several slotted plate layers, (i.e., N1=N2>1), so that eddy current components resulting from leakage fields are also suppressed in the lower-lying plate layers, although the leakage fields are less pronounced there.

Each plate layer of the first group and each plate layer of the second group nay have not only one but several slots. Viewed in a third direction U which stands perpendicular to the first direction R and to the second direction A, the slots of a respective plate layer are positioned so as to be arranged one behind the other.

Furthermore, the plate layers of the first and second group are formed, and the slots there are respectively positioned and arranged, such that at least the plate layers of a respective group are congruent when viewed in the second direction A. In other words, in particular also the slots in the plate layers of a respective group are situated at the same location in the third direction U and in the first direction R, and have the same dimensions, in particular the same extent in the first direction R.

A corresponding electric machine has a circular or annular rotor and a circular or annular stator. The stator has a plurality of such stator teeth which are arranged one behind the other when viewed in a circumferential direction U of the stator, such that the respective tooth foot lies on a ring of the stator or is integrated in the ring or forms the ring, the respective tooth head faces the rotor, the first direction R corresponds to a radial direction of the electric machine, the second direction A corresponds to an axial direction of the electric machine, and the third direction U corresponds to the circumferential direction. The losses described initially are accordingly minimized in this machine equipped with the special stator teeth.

Each stator tooth has a stator winding which is wound onto the respective tooth neck and causes a main magnetic flux H through the stator tooth as soon as electric current flows through it. The slots of the stator tooth are now oriented so as to run parallel to the field lines of the main magnetic flux H, so that the main magnetic flux H is not obstructed, because such an obstruction would lead to a reduction in power density.

An air gap with a radial extent is is formed between the rotor and the stator, and the plate layers each have a thickness bd in the axial direction. For the numbers N1, N2 of plate layers provided with slots in the first and second group, substantially N1=N2=K/2=ls/bd. For the probable case in which ls/bd is not an integer, naturally the closest integer to the quotient ls/bd may be determined by mathematical rounding and used for K/2.

An aircraft, (e.g., an airplane or helicopter), may be equipped with such an electric or hybrid-electric drive including one or more electric machines. At least one of the electric machines may then be configured as an electric motor for driving a propeller of the aircraft. Alternatively, or additionally, at least one of the electric machines may be configured as a generator for providing electrical energy, e.g., for an electrical energy accumulator and/or for an electric motor for driving a propeller of the aircraft.

With the proposed solution, accordingly significantly lower torque losses and power losses may be achieved. The main magnetic flux in the respective stator tooth is only slightly influenced by the orientation of the slots. The power loss is however substantially reduced without significantly influencing the torque formation. Because the peripheral condition of power loss, in particular in the end regions, is no longer relevant for the machine design, a more powerful design may be achieved for the same weight and volume of the electric machine. Accordingly, it is therefore possible to produce electric machines with less material usage and/or with more favorable materials.

Further advantages and embodiments may be found in the drawings and the corresponding description.

### BRIEF DESCRIPTION OF THE DRAWINGS

The disclosure and exemplary embodiments will be explained in more detail below with reference to drawings. There, the same components are identified by the same reference signs in various figures. It is therefore possible that, when a second figure is being described, no detailed explanation will be given of a specific reference sign that has already been explained in relation to another, first figure. In such a case, it may be assumed for the embodiment of the second figure that, even without detailed explanation in relation to the second figure, the component identified there by this reference sign has the same properties and functionalities as explained in relation to the first figure. Furthermore, for the sake of clarity, in some cases not all the reference signs are shown in all of the figures, but only those to which reference is made in the description of the respective figure.

FIG. 1 depicts an axial view of an electric machine, according to an embodiment.

FIG. 2 depicts a tangential section through a stator or stator tooth, according to an embodiment.

FIG. 3 depicts an axial view of a conventional stator tooth, according to an embodiment.

FIG. 4 depicts an axial view of a stator tooth, according to an embodiment.

FIG. 5 depicts a tangential section through a first design of a stator tooth, according to an embodiment.

FIG. 6 depicts a tangential section through a second design of a stator tooth according to an embodiment.

FIG. 7 depicts an aircraft with hybrid-electric drive, according to an embodiment.

### DETAILED DESCRIPTION

As disclosed herein, terms such as “axial”, “radial”, “tangential”, or “in the circumferential direction”, etc. relate to the shaft or axis ROT used in the respective figure or in the example described in each case. In other words, the directions axial A, radial R, and tangential U relate to a rotational axis ROT of the rotor. “Axial” describes a direction A parallel to the rotational axis ROT, “radial” describes a direction R orthogonal to the rotational axis ROT, toward or away therefrom, and “tangential” is a movement or direction U orthogonal to the axis ROT and orthogonal to the radial direction R, which is thus directed in a circle around the rotational axis ROT, at a constant radial distance from the rotational axis ROT and with a constant axial position. The tangential direction U may optionally also be referred to as the circumferential direction U.

Furthermore, the terms “axial”, “radial”, or “tangential”, respectively, in the context of an area, (e.g., a surface), mean that the normal vector of the respective axial, radial, or tangential surface is oriented in the axial, radial or tangential direction, whereby the orientation of the respective area in space is unequivocally described.

The term “electromagnetic interaction” means the interaction, known in an electric machine, between the magnetic fields of the magnetic components or devices the rotor, (e.g., permanent magnets), and the magnetic components or devices of the stator, (e.g., powered coils), on the basis of which the electric motor develops its torque or on the basis of which a generator supplies an electric current.

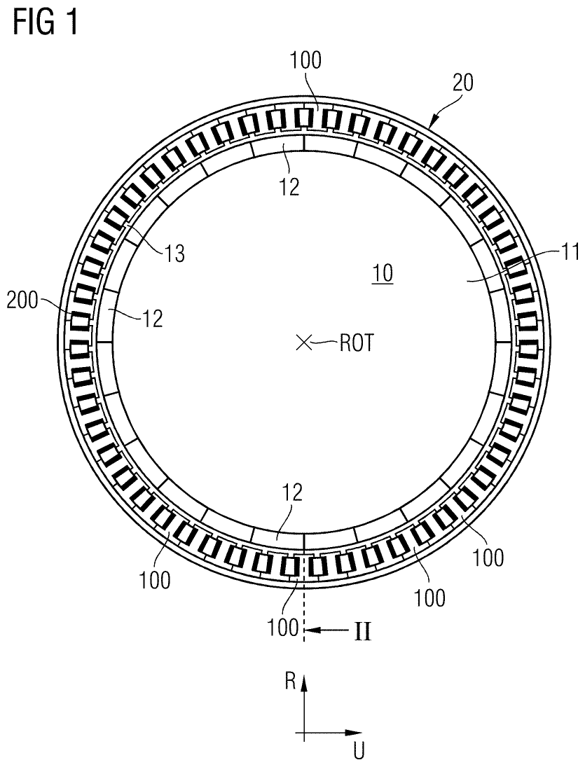

FIG. 1 shows a stator 20 which may be used for an electric machine 1, e.g., for an electric motor. Further peripheral devices required for operation of the machine 1, such as, e.g., a power source to provide a current to be fed into the stator windings to be described, or a consumer of a current induced in the stator windings, are not shown for reasons of clarity. A rotor 10 of the electric machine 1 is only indicated vaguely. The rotor 10 has a base body 11 and a ring including permanent magnets 12. In operation, the rotor 10 rotates about the rotational axis ROT. In operation of the electric machine 1, the permanent magnets 12 (of which for reasons of clarity only a few are marked with reference signs) interact electromagnetically in the known fashion with the stator windings via an air gap 13, so that the machine 1 functions in the desired operating mode as a generator or as an electric motor.

The stator 20 has a plurality of stator teeth 100 which are arranged one behind the another in the circumferential direction U of the stator 20, and of which only a few are marked with reference signs. Each of the stator teeth 100, of which as an example some are shown enlarged in the other figures, carries a winding 200 of a respective tooth coil of a stator winding system of the electric machine 1. Because the tooth coils and the corresponding windings 200 play no essential role below, they are not described in more detail here. Depending on the operating mode of the machine 1 as a generator or an electric motor, the electromagnetic interaction with the permanent magnets 12 of the rotating rotor 10 induces a voltage in the stator windings 200 or tooth coils which would not be receivable at the terminals depicted. Alternatively, a power source feeds currents into the stator windings 200 in order thus to achieve an electromagnetic interaction with the permanent magnets 12 and hence cause a rotation of the rotor 10.

In electric machines 1 such as that shown here, because of inter alia the limitation of the heat flow to the environment and the resulting heating of temperature-critical components, losses occur which limit the achievable power density. The losses occurring in the active material of a stator 20 are known as copper and core losses, wherein the core losses may in turn be divided into hysteresis and eddy current losses.

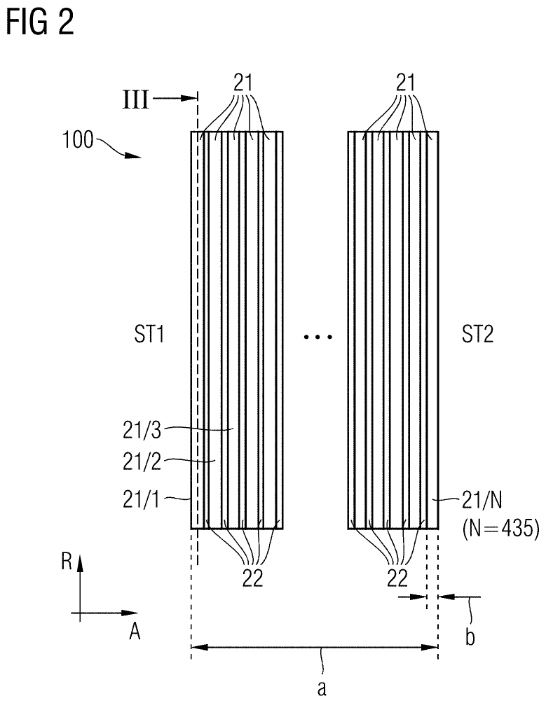

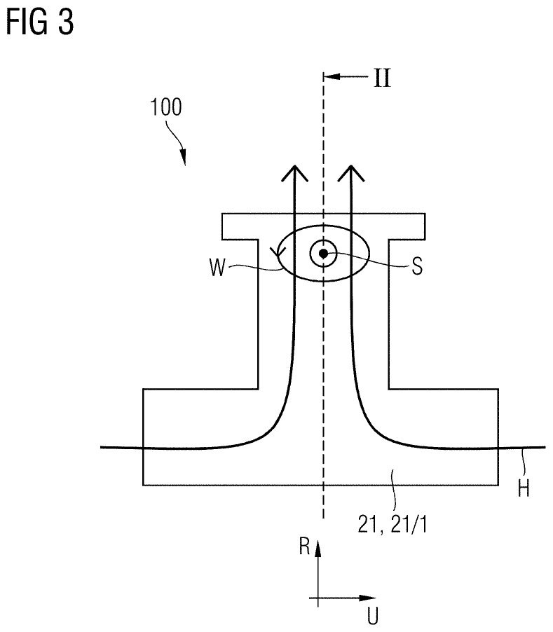

Eddy current losses result from electrical eddy currents W in the core of the stator 20, which are themselves provoked by the main magnetic flux H. This is illustrated schematically in FIG. 3. In order to limit the eddy currents W and the corresponding losses, the stator 20 and hence the stator teeth 100 may be designed in plated form in the known fashion. Such a design is known in itself and means that (as indicated in FIGS. 2, 5 and 6) the stator 20 and hence the stator teeth 100 include a plurality N of largely identical plate layers 21 which are stacked one upon the other congruently in the axial direction.

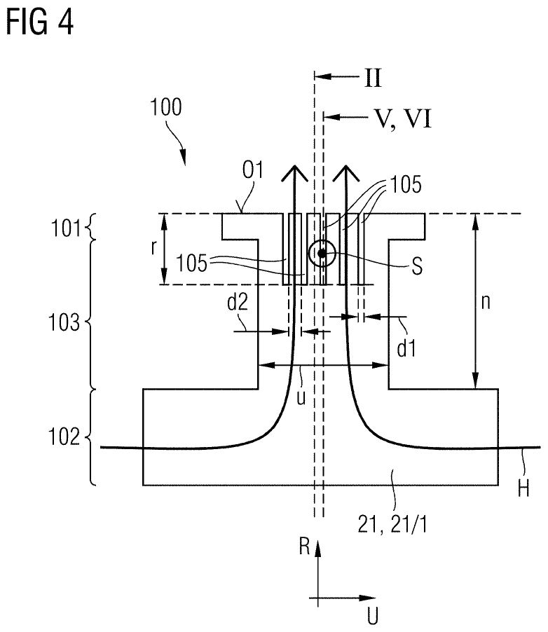

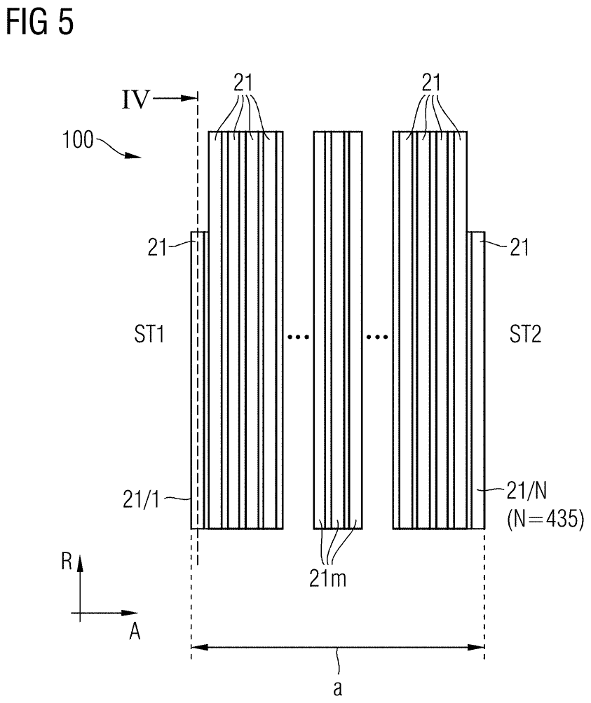

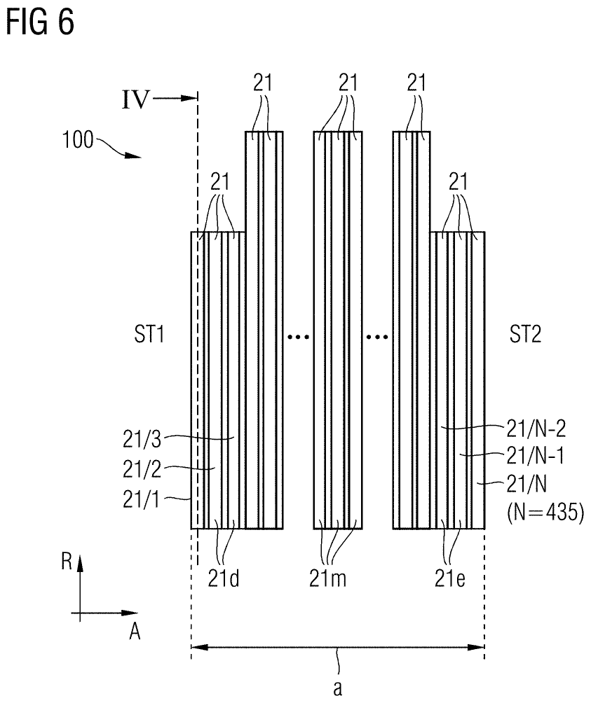

FIG. 2 and FIG. 5 show a respective tangential view II and V of the stator tooth 100 of the stator 20 and the corresponding plate layers 21, corresponding to the sections marked “II” in FIGS. 1, 3, and 4 and “V” in FIG. 4, in the respective R-A planes. Individual plate layers are designated 21/1, 21/2, 21/3, . . . , wherein the plate layers 21/i are numbered incrementally with i=1, . . . , N starting from the plate layer 21/1 on the side of the end region ST1. In one example, the stator 20 may have an active length of a=100 mm and be constructed from approximately N=435 plate layers, giving a plate thickness of b=0.23 mm. For reasons of clarity, not all N=435 plate layers 21 are depicted or marked with reference signs in FIGS. 2 and 5 and also in FIG. 6. The plate layers 21/l and 21/N form the plate layers delimiting the respective stator tooth 100 in the axial direction A, e.g., are the first plate layers 21/l and 21/N of the stator tooth 100 viewed from the respective end region ST1 and ST2. In the illustrations in FIGS. 2, 5 and 6, the delimiting plate layer 21/435 may be designated 21/N below, in order to indicate that it is the last or an axially outer plate layer.

Between two adjacent plate layers 21/i and 21/i+1 is an electrically isolating layer 22, including a so-called baking lacquer. The presence of the isolating layers 22 means that components of the current paths of the eddy currents W in a direction perpendicular to the respective isolating layer 22 are interrupted, and corresponding axial eddy currents are avoided. Eddy current components W within a respective plate layer 21, (e.g., in the R-U plane shown in FIG. 3), may continue to flow largely unobstructed and hence lead to losses.

FIG. 3 shows a form of a stator tooth 100 in the axial viewing direction A, the main magnetic flux H that may occur in the stator tooth 100 in operation of the corresponding electric machine 1, and the magnetic leakage flux S. The main flux H leads to no eddy currents because of the described coating or plate layer arrangement which is not visible in FIG. 3. In contrast however, because of its orientation with respect to the plate layers 21, the leakage flux S results in the eddy current W depicted in FIG. 3, which leads to the losses described.

These eddy current components W in the plate planes of the plate layers 21, (e.g., in the R-U planes), are particularly pronounced in the two plate layers 21/l, 21/N delimiting the respective stator tooth 100 in the axial direction A, e.g., at the end regions ST1, ST2 of the machine 1 or stator 20. These eddy currents W result from the magnetic leakage field S in the respective end region ST1, ST2, which—in contrast to the main flux H—is oriented not in the radial direction R and tangential direction U, but in particular also in the axial direction A and hence perpendicular to the plate layers 21. These axial components of the leakage field S in particular cause comparatively greater eddy currents W in the plate layers 21 lying close to the end regions ST1, ST2, (e.g., in the axially outer layers 21/l, 21/N of the stator tooth 100), and hence locally very high loss densities. In particular in electric machines 1 with small axial extent, the corresponding eddy current losses in the end regions ST1, ST2 constitute a dominant proportion of the total losses in the core.

FIG. 4 corresponds to the view of FIG. 3, (e.g., an axial view onto a stator tooth 100), but shows a design of the stator tooth 100 according to the present disclosure. The stator tooth 100 has a first portion 101 or a tooth head 101 which faces the rotor 10 in the state installed in the machine 1. Furthermore, the stator tooth has a second portion 102 or tooth foot 102 which, in the state installed in machine 1, bears on or is integrated in or forms a corresponding second region of an adjacent stator tooth 100 of the stator 20. In the design of the stator 20 shown in FIG. 1, in which in principle the teeth 100 form the stator 20 and there is no separate ring or similar on which the teeth 100 would be fixed, the second portions 102 or tooth feet 102 of the quantity of stator teeth 100 thus form a closed ring. Between the first portion 101 and the second portion 102 is a third portion 103 or tooth neck 103 which, in the state installed in the machine 1, extends in the radial direction R between the first portion 101 and the second portion 102. The first portion 101 and second portion 102 may protrude beyond the third portion 103, viewed respectively in the positive and negative tangential directions U, and the third portion 103 is used for placing there the windings 200 of the tooth coils (only shown in FIG. 1).

According to the disclosure, slots 105 are made at least in the region of the first portion 101 of the stator tooth 100, and extend in the first portion 101 starting from the surface O1 of the tooth 100, which faces the rotor 10 in the state installed in the stator 20 and the machine 1, substantially in the longitudinal direction of the tooth 101, e.g., from the first portion 101 towards the second portion 102. In the state installed in the stator 20 or in the machine 1, this longitudinal direction corresponds to the radial direction R. The slots 105 may be arranged parallel to the field lines of the main magnetic flux H so as not to obstruct this, because such an obstruction would lead to a reduction in the power density. The slots 105 may be arranged parallel to one another and parallel to the A-R plane, e.g., their extent r in the R direction is substantially greater than their extent or thickness d in the U direction. The extent r may be selected such that the slots 105 reach from the surface O1, over the first portion 101, up to the third portion 103. The extent a in the axial direction A corresponds to the axial extent of the plate layer 21 of the stator tooth 100 in which the respective slot 105 is formed, e.g., the thickness a of this plate layer 21.

The slots 105 in principle have the same effect as the isolating layers 22, namely, to interrupt current paths of corresponding eddy currents. Because of the particular arrangement and orientation of the slots 105, in particular they suppress a tangential component of the eddy current W, which would otherwise be provoked in particular by the leakage field S in the respective plate layer 21, as was shown in FIG. 3.

FIG. 4 shows, as an example and for the sake of clarity, only five slots 105 along the extent of the stator tooth 100 in the circumferential direction U. In practice, with a tooth width u=10 mm, e.g., 10 slots may be provided. The decision on the number of slots 105 limiting the eddy current in this direction U firstly takes into account the fact that, as the number of slots 105 rises, (e.g., as the region perpendicular to the leakage field S in which eddy currents may form becomes smaller), the reduction in eddy current losses is improved. Secondly however, too high a number of slots 105 in the respective plate layer 21 proves disadvantageous, because a higher saturation occurs in the remaining plate volume, which is reduced correspondingly to the higher number.

With respect to the number of slots 105 in a plate layer 21, for example, 10 slots per cm in the U direction may form a starting value. In principle, the aim is for the thickness d of the slots 105 in the U direction to be selected as small as possible, e.g., d=0.1 mm. For a stator tooth 100 with a groove depth n=15 mm and a tangential extent u of u=10 mm in particular in the third region 103, the slots 105 may be dimensioned and may be evenly distributed in the U direction such that, for the depth r of the slots 105 in the R direction, r=7 mm. Advantageously, the slot depth r is selected with respect to the groove depth n such that ⅓<r/n<½, because the strongest leakage fields is expected in these regions or in the corresponding portions 101, 103 of the stator tooth 100.

It is possible, but not necessarily the case, that slots are provided in each plate layer 21. The slots 105 are however provided at least in the two plate layers 21/l and 21/N delimiting the respective stator tooth 100 in the axial direction A, (e.g., in the first plate layer 21/l and in the last plate layer 21/N), and hence in the immediate vicinity of the end regions ST1, ST2 of the machine 1 or stator 20, because the influence of the leakage field S is at a maximum in these axially outer plate layers 21/l, 21/N. FIG. 5 shows a corresponding design, and in particular the section marked “V” in FIG. 4 in the R-A plane, and hence a view in the circumferential direction U at the location of one of the slots 105. As clearly shown there, in this design only the axially outer plate layers 21/l, 21/N are provided with slots 105 so as to give the slot arrangement illustrated in FIG. 4. The slots 105 may be filled with the baking lacquer on baking of the plate layers 21 with the baking lacquer mentioned as an example above. However, this is not illustrated in the figures.

When establishing the total number K of plate layers 21 provided with slots 105, the width a of the respective tooth 100 in the axial direction A may serve as a starting point. Optimization is possible for example in the context of a 3D-FEM simulation, wherein, e.g., the aim may be to achieve the best efficiency or the best shaft power for a given upper limit for the local power loss. As already stated, the influence of the leakage field S is at its strongest in the end regions ST1, ST2 of the stator 20 and hence in the plate layers 21/l, 21/N located there and delimiting the stator tooth 100 in the axial direction A, and at its weakest in the plate layers 21m lying in the middle of the stator tooth 100 in the axial direction A. In FIGS. 4 and 5, as an example, M=3 such “middle” plate layers 21m are shown. Depending on whether the total number N of plate layers 21 is even or odd, the number M of “middle” plate layers 21m is also even or odd. For example, in the case where, in contrast to FIGS. 2, 5 and 6, the total number N of plate layers 21 is even with N>2, the number M of “middle” plate layers 21m would also be even with M≥2.

Because the influence of the leakage field S diminishes significantly in the direction of the tooth middle or in the middle plate layers 21m arranged there, it is not necessary to provide slots 105 in all plate layers 21. In particular, it is not necessary to provide slots in the plate layers 21m lying in the middle of the stator tooth 100 in the axial direction A. FIG. 6 also shows as an example the section marked “VI” in FIG. 4 in the R-A plane, and hence a view in the circumferential direction U at the location of one of the slots 105. As evident from FIG. 6, in this design—as in FIG. 5—the axially outer plate layers 21/l, 21/N are slotted. In addition, in FIG. 6, the second and third plate layers 21d and 21e from the outside in the axial direction A, (e.g., viewed from the end regions ST1, ST2), are also slotted. In FIG. 6, again as an example and for the sake of clarity, only the respective first three plates layers 21/l, 21d or 21/N, 21e, starting from the respective end face ST1, ST2, are slotted.

In general, viewed from the axial end regions ST1, ST2, at least the respective first plate layer 21/l, 21/N, but possibly also further plate layers 21d, 21e may be provided with slots 105, wherein these may be configured so as to give a symmetrical picture when viewed in the tangential direction U. In other words, viewed in the axial direction A, on both sides of the central plate layers 21m, the same number K/2 of slotted plate layers 21/l and possibly 21d, or 21/N and 21e, are provided. Because either N and M are even, or N and M are odd, this may be expressed as K/2=(N−M)/2. In the extreme case, all plate layers 21, (i.e., plate layers 21/l, 21/N, 21d, 21e, 21m), may be provided with slots 105.

In practice, when establishing the total number K of plate layers 21 provided with slots 105, for example the width ls of the air gap 13 between the stator 20 and rotor 10 may be taken into account. For the number K/2 of slotted plates 21 per side ST1, ST2, for example K/2=air gap width/plate thickness=ls/(a/N). With the above-mentioned parameters a/N=0.23 mm and an air gap of, e.g., ls=2 mm, this gives a number K/2=9 slotted plate layers on each side ST1, ST2.

The slots 105 may be introduced by laser cutting on production of the plate layers 21. Because this machining may have negative effects on the magnetic properties in the edge region of the respective cut edges, it is suitable to anneal the plates 21 before further processing. The slot width d1 may be lasered to d=0.1 mm. Thermal stress may be largely avoided here in order to obtain the magnetic properties of the plate 21. The distances d2 between two adjacent slots, with a tooth width of, e.g., a=10 mm, may be d2=0.5-1.0 mm.

For the sake of completeness, the section designated “II” in FIG. 4 but not located at the site of one of the slots 105, is shown in the above-mentioned FIG. 2, and naturally corresponds to the tangential view of a stator tooth 100 which has no slots.

The proposed solution may be transferred to all machines and actuators in which magnetic flux is conducted in plated cores and an end region ST1, ST2 is present. A significant reduction in end losses by more than half appears possible from initial design calculations.

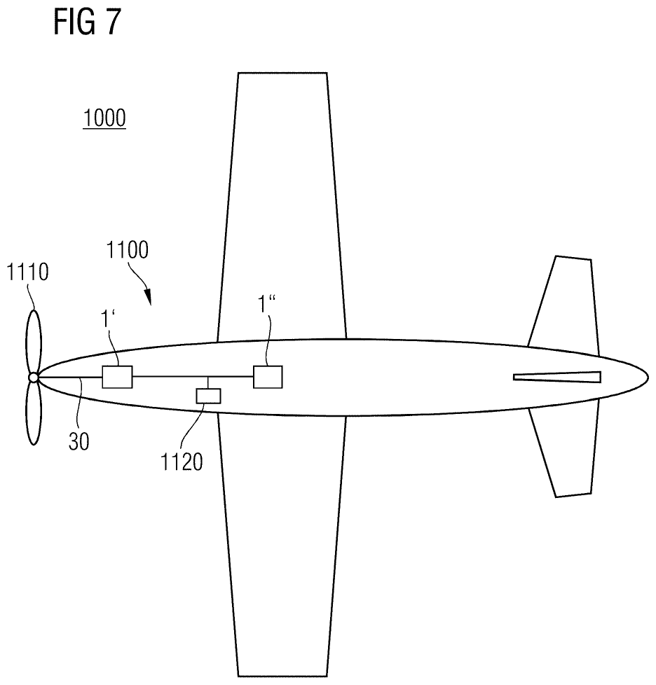

FIG. 7 shows an aircraft 1000 with an electric drive 1100, wherein the term “electric drive” also includes a hybrid-electric drive. The drive 1100 includes an electric machine 1′ which is configured like the machine 1 described above, and in particular has the slotted stator teeth 100 (not shown in FIG. 7).

The electric machine 1′ is here operated as an electric motor 1′ and has a shaft 30 which is rotationally fixedly connected to the rotor 10. The shaft 30 is itself connected to a propeller 1110 of the drive 1100, so that in operating state, the motor 1 drives the propeller 1110 in the known fashion and thus provides thrust for the aircraft 1000. The electrical energy for operating the electric motor 1′ is provided for example from an electrical energy accumulator 1120 and/or from a generator 1″ as described below.

In a further embodiment, the drive 1100 has a further electric machine 1″ which is operated as a generator. This generator 1″ is also configured like the machine 1 described above, and in particular has the slotted stator teeth 100 (not shown in FIG. 7). The generator 1″ is configured and integrated in the drive system 1100 such that it supplies electrical energy, e.g., for the electrical energy accumulator 1120 and/or for the electric motor 1′.

Finally, an embodiment of the stator 20 has been described here in which the stator 20 includes the stator teeth 100. This is meant purely as an example. Stators are also known which, for example, have a stator ring on which the stator teeth are attached. In the case of a plated stator, then not only the stator teeth but also the ring may be configured in plated form.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present disclosure has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A stator tooth for a stator of an electric machine, the stator tooth comprising:
a tooth head,
a tooth foot; and
a tooth neck positioned between the tooth head and the tooth foot in a first direction,
wherein slots are provided in the tooth head which extend from the tooth head in a direction towards the tooth foot and are arranged and oriented such that eddy current components configured to be provoked by a magnetic leakage field acting in a region of the stator tooth in operation of the electric machine are at least reduced.

2. The stator tooth of claim 1, wherein the slots extend from a surface of the tooth head facing away from the tooth foot, in the first direction towards the tooth foot.

3. The stator tooth of claim 2, wherein the slots extend into the tooth neck.

4. The stator tooth of claim 3, wherein, as viewed in the first direction, the stator tooth has a groove depth n and the slots have a slot depth r, and
wherein a ratio of slot depth r to groove depth n is in a range of: ⅓<r/n<½.

5. The stator tooth of claim 4, wherein the slots are oriented such that, in a state installed in the electric machine, the slots extend parallel to field lines running in a region of the slots of a main magnetic flux occurring in the operation of the electric machine.

6. The stator tooth of claim 1, wherein the stator tooth comprises a plurality of separate plate layers stacked one upon the other in a second direction, which is perpendicular to the first direction,
wherein the plurality of plate layers is divided into a first group with N1 plate layers, a second group with N2 plate layers, and an optional third group with N3 plate layers, wherein N1+N2+N3=N and N1≥1, N2≥1, and N3≥0, and wherein the three groups are stacked one upon the other such that, as viewed in the second direction, the optional third group is arranged between the first group and the second group, and
wherein each plate layer of the first group and each plate layer of the second group has at least one slot.

7. The stator tooth of claim 6, wherein the first group and the second group each comprise a plurality of plate layers.

8. The stator tooth of claim 6, wherein each plate layer of the first group and each plate layer of the second group has several slots, and
wherein the slots of a respective plate layer are arranged one behind the other when viewed in a third direction U which is perpendicular to the first direction and to the second direction.

9. The stator tooth of claim 8, wherein the plate layers of the first and second group are provided, and the slots of the plate layers are respectively positioned and arranged, such that the plate layers of a respective group are congruent when viewed in the second direction.

10. An electric machine comprising:
a circular or annular rotor; and
a circular or annular stator,
wherein the stator comprises a plurality of stator teeth, each stator tooth comprising a tooth head, a tooth foot, and a tooth neck positioned between the tooth head and the tooth foot in a radial direction of the electric machine,
wherein slots are provided in the tooth head which extend from the tooth head in a direction towards the tooth foot and are arranged and oriented such that eddy current components configured to be provoked by a magnetic leakage field acting in a region of the stator tooth in operation of the electric machine are at least reduced, and
wherein the stator teeth are arranged one behind the other when viewed in a circumferential direction of the stator such that: a respective tooth foot of a respective stator tooth bears on a ring of the stator, is integrated in the ring, or forms the ring; and the respective tooth head faces the rotor.

11. The electric machine of claim 10, wherein each stator tooth has a stator winding wound onto the respective tooth neck and configured to cause a main magnetic flux through the stator tooth when an electric current flows through the stator tooth, and
wherein the slots of the respective stator tooth are oriented so as to run parallel to the field lines of the main magnetic flux.

12. The electric machine of claim 10, wherein each stator tooth comprises a plurality of separate plate layers stacked one upon the other in an axial direction of the electric machine, which is perpendicular to the radial direction and the circumferential direction of the electric machine,
wherein the plurality of plate layers is divided into a first group with N1 plate layers, a second group with N2 plate layers, and an optional third group with N3 plate layers, wherein N1+N2+N3=N and N1≥1, N2≥1, and N3≥0, and wherein the three groups are stacked one upon the other such that, as viewed in the axial direction, the optional third group is arranged between the first group and the second group,
wherein each plate layer of the first group and each plate layer of the second group has at least one slot,
wherein an air gap with a radial extent ls is positioned between the rotor and the stator, and
wherein each plate layer of the plurality of plate layers has a thickness bd in the axial direction A, characterized in that for the numbers N1, N2 of plate layers provided with slots in the first group and the second group G2, N1=N2=K/2=ls/bd.

13. An aircraft comprising:
an electric or hybrid-electric drive having one or more electric machines, each electric machine of the one or more electric machines comprising:
a circular or annular rotor; and
a circular or annular stator,
wherein the stator comprises a plurality of stator teeth,
wherein each stator tooth comprises a tooth head, a tooth foot, and a tooth neck positioned between the tooth head and the tooth foot in a radial direction of the respective electric machine,
wherein slots are provided in the tooth head which extend from the tooth head in a direction towards the tooth foot and are arranged and oriented such that eddy current components configured to be provoked by a magnetic leakage field acting in a region of the stator tooth in operation of the electric machine are at least reduced, and
wherein the stator teeth are arranged one behind the other when viewed in a circumferential direction of the stator such that: a respective tooth foot of a respective stator tooth bears on a ring of the stator, is integrated in the ring, or forms the ring; and the respective tooth head faces the rotor.

14. The aircraft of claim 13, wherein at least one of the electric machines is configured as an electric motor for driving a propeller of the aircraft.

15. The aircraft of claim 14, wherein at least one of the electric machines is configured as a generator for providing electrical energy.

16. The aircraft of claim 13, wherein at least one of the electric machines is configured as a generator for providing electrical energy.

17. The stator tooth of claim 6, wherein the first group and the second group have a same number of plate layers with N1=N2.

18. The stator tooth of claim 7, wherein each plate layer of the first group and each plate layer of the second group has several slots, and
wherein the slots of a respective plate layer are arranged one behind the other when viewed in a third direction U which is perpendicular to the first direction and to the second direction.

19. The stator tooth of claim 18, wherein the plate layers of the first and second group are provided, and the slots of the plate layers are respectively positioned and arranged, such that the plate layers of a respective group are congruent when viewed in the second direction.
